(19) United States
(12) Patent Application Publication
(10) Pub. No.: US 2004/0263915 A1
(43) Pub. Date: Dec. 30, 2004

(54) Image scanning method and apparatus

(75) Inventor: Bok-ki Park, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/875,164

(22) Filed: Jun. 25, 2004

(30) Foreign Application Priority Data
Jun. 27, 2003 (KR) 2003-42771

(51) Int. Cl. H04N 1/40; H04N 1/46

(52) U.S. Cl. 358/461; 358/509

(57) ABSTRACT

An image scanning method in which image data acquired from a scan object illuminated by a light source is compensated using shading compensation factors obtained by performing a dummy scan on a white sheet illuminated by the light source. The image scanning method includes obtaining a first luminance value of the light source during the dummy scan, obtaining a second luminance value of the light source during an image scan, and updating the shading compensation factors based on the first luminance value and the second luminance value.

### CROSS-REFERENCE TO RELATED APPLICATIONS

This application claims the priority of Korean Patent Application No. 2003-42771, filed on Jun. 27, 2003, in the Korean Intellectual Property Office, the disclosure of which is incorporated herein by reference.

### BACKGROUND OF THE INVENTION

1. Field of the Invention

The present invention relates to an image scanning method and apparatus, and more particularly, to a flatbed scanning apparatus using a cold cathode fluorescent lamp (CCFL), by which a start delay due to a warm-up of a lamp for scanning is reduced, and a method therefor.

2. Description of the Related Art

Image scanning machines such as scanners and copiers that use a CCFL as a light source require a large amount of time for a warm-up of the light source before scanning images after a power switch is turned on. Warm-up time is a minimum time required to obtain an appropriate light level and light emission stability for acquisition of good quality image data. The warm-up is related with evaporation of liquid mercury within a CCFL. Generally, it takes about 1 to 3 minutes to sufficiently evaporate mercury within a CCFL included in an image scanning apparatus to emit light normally.

As is described above, an image scanning apparatus having a CCFL as a light source can read an image after a strength of the light source reaches a predetermined level after power is applied to the image scanning apparatus. Even after the strength of the light source reaches the predetermined level due to a warm-up, when a white sheet is scanned using an image sensor, an appropriate white level, for example, 255 in an 8-bit system, is not obtained due to a shading phenomenon caused by variation among pixels in the image sensor. This variation occurs because the pixels of the image sensor output different values with respect to incident light having uniform intensity. To reduce such variation in outputs among pixels of an image sensor, shading compensation or correction is performed by carrying out a dummy scan on a reference white sheet before scanning a document to obtain a shading compensation factor with respect to the pixels, and adjusting a white level of each pixel using the shading compensation factor. The reference white sheet is disposed between a home position of the image sensor and a scan area where the document is positioned.

If shading compensation is performed before satisfactory brightness and stable light emission are achieved due to an incomplete warm-up of a light source, the shading compensation cannot be successful since brightness of the light source continuously increases during the shading compensation. In other words, successful shading compensation cannot be guaranteed until a light source is sufficiently warmed up to provide satisfactory brightness and stabilized variation of brightness within a predetermined range. For this reason, a conventional image scanning apparatus is configured such that shading compensation is performed after a warm-up.

### SUMMARY OF THE INVENTION

The present invention provides a method and apparatus for scanning images, by which a scan delay due to a warm-up is minimized so that an image scan can be started quickly.

The present invention also provides a method and apparatus for scanning images, by which a shading compensation factor is effectively updated so that a good-quality image can be scanned.

According to an aspect of the present invention, there is provided an image scanning method by which image data acquired from a scan object illuminated by a light source is compensated using shading compensation factors obtained by performing a dummy scan on a white sheet illuminated by the light source. The image scanning method comprises obtaining a first luminance value of the light source during the dummy scan, obtaining a second luminance value of the light source during an image scan, and updating the shading compensation factors based on the first luminance value and the second luminance value.

According to one aspect, the light source is a linear cold cathode fluorescent lamp (CCFL). According to one aspect, the dummy scan and the image scan are performed by an image sensor disposed to be parallel with the CCFL in a direction in which the CCFL extends, and the first and second luminance values are obtained using dummy pixels provided on the image sensor.

According to one aspect, the first and second luminance values are obtained from the white sheet illuminated by the light source.

According to another aspect of the present invention, there is provided an image scanning method comprising illuminating a white sheet using a light source; performing a dummy scan on the white sheet using an image sensor and calculating shading compensation factors for the image sensor; calculating a first luminance value of the light source during the dummy scan; performing a line scan using the image sensor while illuminating a scan object using the light source; counting a number of lines scanned by the line scan and determining whether a predetermined number of lines have been scanned; when it is determined that the predetermined number of lines have been scanned, calculating a second luminance value of the light source at a current scan line; comparing the first luminance value with the second luminance value and updating the shading compensation factors according to a difference between the first luminance value and the second luminance value; and performing compensation on an image signal, obtained by the line scan, using the shading compensation factors.

According to one aspect, the light source is a linear cold cathode fluorescent lamp (CCFL). According to one aspect, the dummy scan and the line scan are performed by the image sensor which is disposed to be parallel with the CCFL in a direction in which the CCFL extends, and the first and second luminance values are obtained using dummy pixels provided on the image sensor.

According to one aspect, the second luminance value is obtained from the white sheet illuminated by the light source using the dummy pixels of the image sensor.

According to still another aspect of the present invention, there is provided an image scanning apparatus comprising a charge coupled device (CCD) assembly which comprises a light source and an image sensor; a white sheet which comprises a dummy scan portion used to calculate shading compensation factors and an initial luminance value before an image scan, and a luminance detection portion used to calculate a real-time luminance value during the image scan; a memory which stores the shading compensation factors; a shading compensation factor updater which updates the shading compensation factors using a luminance signal obtained by the image sensor; and a shading compensator which performs compensation on image data obtained by the image sensor using the shading compensation factors.

According to one aspect, the image sensor comprises dummy pixels corresponding to the luminance detection portion of the white sheet, and a white level is detected using the dummy pixels in the luminance detection portion.

According to one aspect, the light source is a cold cathode fluorescent lamp (CCFL) extending in the same direction as the image sensor. According to one aspect, the dummy scan portion of the white sheet extends in the same direction as the CCFL, and the luminance detection portion of the white sheet extends in a moving direction of the CCD assembly.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a layout illustrating a positional relationship between a white sheet and a charge coupled device (CCD) assembly with respect to a transparent plate on which an image document is placed, according to a first embodiment of the present invention;

FIG. 2 is a schematic block diagram of an apparatus for scanning an image according to the first embodiment of the present invention;

FIG. 3 is a flowchart of a method of scanning an image according to the first embodiment of the present invention; and

FIG. 4 is a flowchart of a method of scanning an image according to a second embodiment of the present invention.

### DETAILED DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

Well known parts or elements such as a cold cathode fluorescent lamp (CCFL), a charge coupled device (CCD), a mirror, a lens optical system, and a CCD assembly of those parts will not be described below even though they are essential to an apparatus for scanning images according to the present invention. In addition, well known circuits related with processing and controlling image signals obtained by the CCD will not be described. Only algorithms by which the present invention can be implemented will be described in detail.

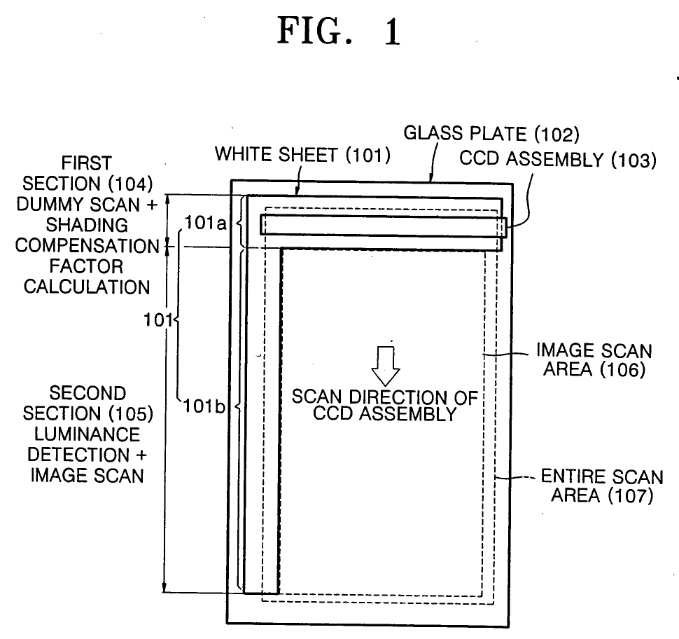

FIG. 1 is a layout illustrating a disposition of a white sheet 101 on a glass plate 102 on which an image document is placed, and a relationship between the white sheet 101 and a CCD assembly 103, according to a first embodiment of the present invention.

Referring to FIG. 1, unlike in a conventional image scanning apparatus, the white sheet 101 includes a dummy scan portion 101 a corresponding to a first section 104 where a dummy scan is performed, and a luminance detection portion 101b corresponding to a second section 105 where luminance of a light source is detected in real time during a main scan. In other words, the white sheet 101 has an upside-down “L” shape, which includes the dummy scan portion 101a corresponding to a home position of the CCD assembly 103, and the luminance detection portion 101b extending straight from a portion of the first section 104 in a scan direction of the CCD assembly 103.

The CCD assembly 103 is designed to scan an entire scan area 107. The entire scan area 107 extends over a part of the first section 104 corresponding to the home position of the CCD assembly 103, where a shading compensation factor is initially detected. The luminance detection portion 101b of the white sheet 101 partially overlaps one side portion of an image scan area 106 where an image is read from a document so that the CCD assembly 103 detects a luminance signal from the luminance detection portion 101b of the white sheet 101 in real time while scanning an image in the image scan area 106. In other words, during an image scan, the CCD assembly 103 reads a white level from the luminance detection portion 101b of the white sheet 101 using dummy pixels of an image sensor positioned outside the image scan area 106. If a white level of a scan line on the white sheet 101 does not exceed an appropriate value (or a limit), shading compensation is performed on read line image data using an existing shading compensation factor. If the white level exceeds the limit, the shading compensation factor is updated based on the current white level, and then shading compensation is performed on the read line image data. As is described above, when a shading compensation factor is updated every scan line, good-quality image data can be acquired without a warm-up of a light source.

In the embodiment shown in FIG. 1, the dummy scan portion 101a and the luminance detection portion 101b of the white sheet 101 are integrally formed. However, in other embodiments of the present invention, the dummy scan portion 101a and the luminance detection portion 101b may be separately formed.

In addition to the above-described hardware structure, a circuit for processing image signals obtained by the image sensor is further provided. The circuit is made using well known electronic parts including a memory which stores software, that is, firmware for performing a series of algorithms, and a system controller that controls an entire scanning apparatus using the firmware to output acquired image signals through an interface card. Such a circuit of an image scanning apparatus according to the present invention can be easily implemented by an algorithm described below.

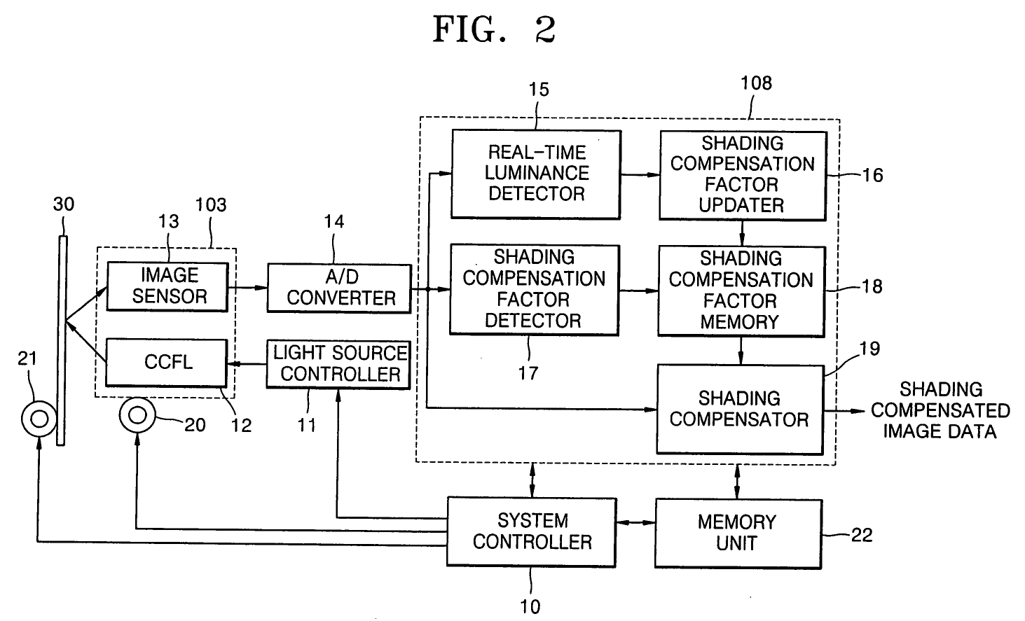

A circuit structure of an image scanning apparatus according to the first embodiment of the present invention will be schematically described with reference to FIG. 2, and a scanning operation will be described with reference to FIGS. 1 and 2.

Similar to a conventional flatbed scanner, in the scanning apparatus shown in FIG. 2, a document 30, an object of an image scan, is stationed WHEN the CCD assembly 103 is moved by a driving unit 20. And when the document 30 is fed by an automatic document feeder (ADF) 21, the CCD assembly 103 is stationed. The driving unit 20 and the ADF 21 are controlled by a system controller 10. The controller 10 entirely controls an image processing unit 108, which temporarily stores image data in a memory unit 22. The controller also controls a light source controller 11, which controls a light source, e.g. the CCFL 12.

The CCD assembly 103 is moved by the driving unit 20 back and forth below the glass plate 102 on which the document 30 is placed and is stationed in a home position area provided below or beyond the dummy scan portion 101a of the white sheet 101 in a standby state. Sheets of the document 30 may be placed on the glass plate 102 one by one or may be continuously fed by the ADF 21. According to one embodiment, the CCD assembly 103 is moved from the first section 104 to the second section 105 by the driving unit 20 to scan an image. According to another embodiment, when the ADF 21 is designed to move the document 30 during a scan while the CCD assembly 103 is stationed, the CCD assembly 103 is positioned at the beginning portion of the second section 105 beyond the first section 104, and the ADF 21 operates to move the document 30 so that the document 30 can be scanned by the stationed CCD assembly 103.

At the beginning of a scan, the CCD assembly 103 reads an image from the dummy scan portion 101a of the white sheet 101, thereby obtaining an analog signal. The analog signal is converted into a digital signal by an analog-to-digital (A/D) converter 14, and then the digital signal is transmitted to a shading compensation factor detector 17. The shading compensation factor detector 17 calculates a shading compensation factor for each of pixels of an image sensor 13 using the digital signal, and stores calculated shading compensation factors in a shading compensation factor memory 18. Meanwhile, a real-time luminance detector 15 detects a luminance or a white level in the first section 104 from the digital signal and calculates a first luminance value corresponding to the shading compensation factors.

After the shading compensation factor and the first luminance value are calculated, the CCD assembly 103 performs a line scan of the image scan area 106 in the second section 105, thereby obtaining a digital signal. The digital signal is processed by the A/D converter 14 and then undergoes compensation performed by a shading compensator 19 using the shading compensation factors stored in the shading compensation factor memory 18, so that shading compensated image data is output. When the line scan has been performed on a predetermined number of lines (corresponding to a period with which the shading compensation factor stored in the memory 18 is updated in response to white level change), the real-time luminance detector 15 calculates a second luminance value for a current line. A shading compensation factor updater 16 compares the second luminance value with the first luminance value and updates the shading compensation factors stored in the shading compensation factor memory 18 according to a comparison result. In other words, according to one embodiment, initially obtained shading compensation factors are updated in response to a luminance of a light source after a predetermined time elapses. As is described above, since shading compensation factors is updated according to a luminance of the light source, which may change over time, the embodiment can realize an image scan through which good-quality image data can be obtained, regardless of luminance of the light source.

When an embodiment of the present invention is applied to an image scanning apparatus using a lamp such as a CCFL, whose luminance continuously increases for a predetermined period of time, that is, a lamp requiring a large amount of warm-up time to emit light stably, a main scan can be performed within a very short time after power is turned on without requiring a long warm-up time, since shading compensation factors are updated according to a change in luminance of the lamp, as is described above. Accordingly, a user can scan an image using the image scanning apparatus immediately after turning it on. In addition, when an embodiment of the present invention is applied to a superprecision image scanning apparatus, from which a desired-quality image cannot be obtained due to even a slight change in luminance that is allowable in a normal scanning apparatus, an excellent quality scan result can be obtained.

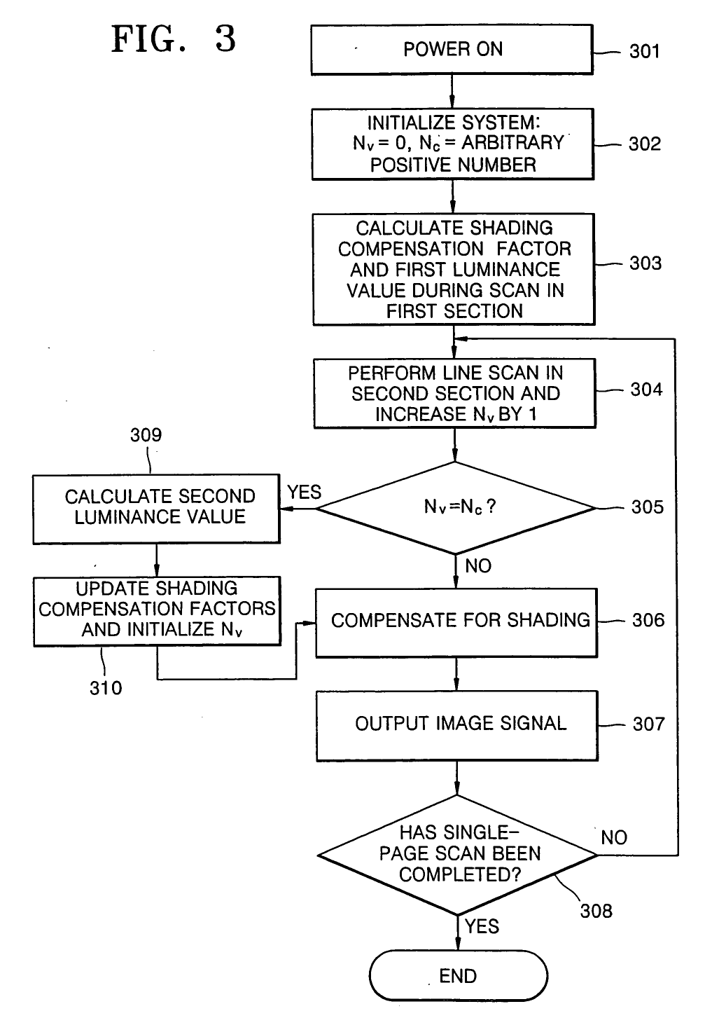

FIG. 3 is a flowchart of a method of scanning an image according to an embodiment of the present invention.

When a scan is started after power is turned on in step 301, an entire system is initialized in operation 302, in which a constant N_{c} for determining a shading compensation factor update period according to luminance change is set to an arbitrary positive number, and a scan line counter variable Nᵥ is initialized to “0”.

In operation 303, shading compensation factors for pixels are calculated using an image signal obtained from the dummy scan portion 101a of the white sheet 101 in the first section 104, and a first luminance value corresponding to initial average luminance of a light source is also calculated. Here, the average luminance is calculated using light information obtained from a plurality of dummy pixels corresponding to the luminance detection portion 101b of the white sheet 101. It is apparent that a single luminance value can be obtained from each pixel. In this case, however, a large luminance calculation error may occur due to variations among the pixels. To reduce the luminance calculation error, luminance values obtained from the respective pixels are averaged. The first luminance value is a white level obtained using the dummy pixels corresponding to the luminance detection portion 101b of the white sheet 101 that are not used while an image scan is being performed in the first section 104 to obtain the shading compensation factors.

In operation 304, a line scan is performed in the second section 105, thereby obtaining line image data, and then the scan line counter variable Nᵥ is increased by, for example, 1, i.e., Nᵥ=Nᵥ+1.

Next, the scan line counter variable Nᵥ is compared with the constant N_{c} to determine whether a predetermined number of scan lines have been performed in operation 305. When it is determined that the predetermined number of scan lines have been performed, i.e., Nᵥ=N_{c}, a second luminance value is calculated in operation 309. When Nᵥ<N_{c}, shading compensation is performed in operation 306.

The second luminance value calculated in operation 309 is an average luminance value of the light source obtained while the line scan is performed in the second section 105. After operation 309, the shading compensation factors are updated according to a difference, for example, a ratio, between the first luminance value and the second luminance value, and the scan line counter variable Nᵥ is initialized in operation 310. Thereafter, the shading compensation is performed in operation 306.

The second luminance value corresponds to a white level obtained using the dummy pixels corresponding to the luminance detection portion 101b of the white sheet 101 that are not used while a main scan is being performed in the second section 105. An increment of the white level of the light source is determined by comparing the first luminance value with the second luminance value, and the shading compensation factors are updated according to the change of the white level.

In operation 306, the image data is compensated for shading using a conventional method. The compensated image signal is output in operation 307. Next, it is determined whether a single-page scan has been completed in operation 308. If it is determined that the single-page scan has not been completed, the method returns to operation 304. Otherwise, the method ends.

In the above-described embodiment of the present invention, the constant N_{c} may be “1” or greater. When the constant N_{c} is “1”, the shading compensation factors are updated every line scan. Updating the shading compensation factors every line scan may decrease an entire scan speed. In addition, when considering a scan speed, luminance change during a single-line scan is not large. Accordingly, it is preferable to set the constant N_{c} to a value much greater than “1”. In other words, it is preferable that the constant N_{c} corresponds to a time interval or a scan line interval at which occurrence of luminance change affecting image data is predicted.

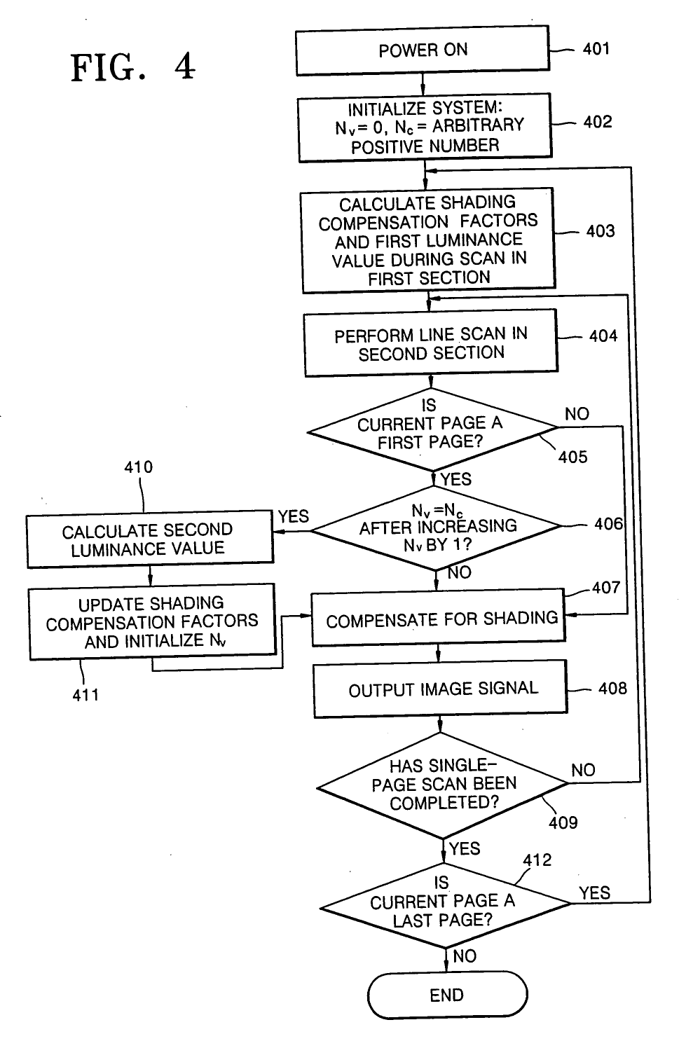

Operations 303 through 310 shown in FIG. 3 are performed on each page of a scanned document. But, luminance stability of the light source is generally achieved during a scan of a first page of the document. According to one embodiment, when a plurality of pages are scanned, operations 303 through 310 shown in FIG. 3 are performed only on a first page, as is shown in FIG. 4 that will be described below, and thereafter, the remaining pages are scanned using a conventional method without updating shading compensation factors. But as stated above, when good-quality image data very sensitive to luminance change is needed, operations 303 through 310 shown in FIG. 3 may be performed on every page of a scanned document.

FIG. 4 is a flowchart of a method of scanning image according to a second embodiment of the present invention. In this embodiment, when a plurality of pages are scanned, a shading compensation factor update using luminance values is performed only on a first page.

Referring to FIG. 4, when a scan is started after power is turned on in operation 401, an entire system is initialized in operation 402. Here, a constant N_{c} for determining a shading compensation factor update period according to luminance change is set to an arbitrary positive number, and a scan line counter variable Nᵥ is initialized to “0”. The scan line counter variable Nᵥ is used only for a first page.

In operation 403, shading compensation factors for pixels are calculated using an image signal obtained from the dummy scan portion 101a of the white sheet 101 in the first section 104, and a first luminance value corresponding to initial average luminance of a light source is also calculated. According to one embodiment, the calculation of shading compensation factors is performed on each page when a plurality of pages are scanned. The first luminance value is used to update shading compensation factors calculated for image data acquired from the first page, and therefore, according to one embodiment, the first luminance value is not calculated for pages other than the first page.

A line scan is performed in the second section 105, thereby obtaining line image data in operation 404. Next, it is determined whether a current page is the first page in operation 405. If it is determined that the current page is the first page, the method goes to operation 406. But if it is determined that the current page is not the first page, the method goes to operation 407.

If it is determined that the current page is the first page, the scan line counter variable Nᵥ is increased by, for example, 1, i.e., Nᵥ=Nᵥ+1, and then the scan line counter variable Nᵥ is compared with the constant N_{c} to determine whether a predetermined number of scan lines have been performed, i.e., whether Nᵥ=N_{c}, in operation 406. If it is determined that Nᵥ=N_{c}, a second luminance value is calculated in operation 410. When Nᵥ<N_{c}, shading compensation is performed in operation 407.

The second luminance value calculated in operation 410 is an average luminance value of the light source obtained while the line scan is performed in the second section 105. After operation 410, the shading compensation factors are updated according to a difference between the first luminance value and the second luminance value, and the scan line counter variable Nᵥ is initialized in operation 411. Thereafter, the shading compensation is performed in operation 407.

In operation 407, the image data is compensated for shading using a conventional method. A compensation result is output as an image signal in operation 408. Next, it is determined whether a single-page scan has been completed in operation 409. If it is determined that the single-page scan has not been completed, the method returns to operation 404. But if it is determined that the single-page scan has been completed, the method goes to operation 412.

In operation 412, it is determined whether the current page is a last page. If it is determined that the current page is not the last page, the method returns to operation 403. When the last page is completely scanned, the method ends.

The embodiment shown in FIG. 4 can be used when a single page or a plurality of pages of a document are scanned in a case where an entire image scanning apparatus is turned on or a light source such as a CCFL is newly turned on after power supply to the light source is interrupted, for example, in a power save mode. As is described above, according to one embodiment, when a second page is scanned, since a light source of a CCD assembly has satisfactory luminance, shading on the second and subsequent pages can be satisfactorily compensated for using a conventional method. But as is described above, according to one embodiment, a shading compensation factor update may be performed on all pages in response to an increase in luminance, i.e., a white level.

According to embodiments of the present invention, shading compensation factors are updated in response to luminance change of a light source at every scan line, or at predetermined scan line intervals, and compensation of an acquired image signal is performed using the updated shading compensation factors, so that good-quality image data can be acquired even when light emission of the light source is instable. When such features of embodiments of the present invention are used, a warm-up time of the light source required in an initial operation of an image scanning apparatus can be remarkably reduced or absolutely eliminated. Accordingly, an image scanning apparatus which can quickly start a scan can be realized.

In addition, since the shading compensation factors can be updated in response to a white level of the light source even after the light source is stabilized, image data of excellent quality can be acquired. Accordingly, a superprecision image scanning apparatus which can provide uniform-quality image data can be realized.

Embodiments of the present invention can be applied to apparatuses requiring an image scan, such as optical scanners and copiers using an optical scanning apparatus. In particular, the present invention can be effectively applied to apparatuses using a light source, such as a CCFL, that has instable light emission and rapid luminance change in an initial operating stage.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image scanning method by which image data acquired from a scan object illuminated by a light source is compensated using shading compensation factors obtained by performing a dummy scan on a white sheet illuminated by the light source, the image scanning method comprising:
obtaining a first luminance value of the light source during the dummy scan;
obtaining a second luminance value of the light source during an image scan; and
updating the shading compensation factors based on the first luminance value and the second luminance value.

2. The image scanning method of claim 1, wherein the updating the shading compensation factors based on the first luminance value and the second luminance value comprises updating the shading compensation factors based on a difference between the first luminance value and the second luminance value.

3. The image scanning method of claim 1, wherein the updating the shading compensation factors based on the first luminance value and the second luminance value comprises updating the shading compensation factors based on a ratio between the first luminance value and the second luminance value.

4. The image scanning method of claim 1, wherein the light source is a linear cold cathode fluorescent lamp (CCFL).

5. The image scanning method of claim 5, wherein the dummy scan and the image scan are performed by an image sensor disposed to be parallel with the CCFL in a direction in which the CCFL extends, and the first and second luminance values are obtained using dummy pixels provided on the image sensor.

6. The image scanning method of claim 1, wherein the first and second luminance values are obtained from the white sheet illuminated by the light source.

7. The image scanning method of claim 4, wherein the first and second luminance values are obtained from the white sheet illuminated by the light source.

8. The image scanning method of claim 5, wherein the first and second luminance values are obtained from the white sheet illuminated by the light source.

9. An image scanning method comprising:
illuminating a white sheet using a light source;
performing a dummy scan on the white sheet using an image sensor and calculating shading compensation factors for the image sensor;
calculating a first luminance value of the light source during the dummy scan;
performing a line scan using the image sensor while illuminating a scan object using the light source;
counting a number of lines scanned by the line scan and determining whether a predetermined number of lines have been scanned;
when it is determined that the predetermined number of lines have been scanned, calculating a second luminance value of the light source at a current scan line;
comparing the first luminance value with the second luminance value and updating the shading compensation factors according to a difference between the first luminance value and the second luminance value; and
performing compensation on an image signal, obtained by the line scan, using the shading compensation factors.

10. The image scanning method of claim 9, wherein the updating the shading compensation factors according to the difference between the first luminance value and the second luminance value comprises updating the shading compensation factors according to a ratio between the first luminance value and the second luminance value.

11. The image scanning method of claim 9, wherein the light source is a linear cold cathode fluorescent lamp (CCFL).

12. The image scanning method of claim 11, wherein the dummy scan and the line scan are performed by the image sensor which is disposed to be parallel with the CCFL in a direction in which the CCFL extends, and the first and second luminance values are obtained using dummy pixels provided on the image sensor.

13. The image scanning method of claim 9, wherein the second luminance value is obtained from the white sheet illuminated by the light source using the dummy pixels of the image sensor.

14. The image scanning method of claim 11, wherein the second luminance value is obtained from the white sheet illuminated by the light source using the dummy pixels of the image sensor.

15. The image scanning method of claim 12, wherein the second luminance value is obtained from the white sheet illuminated by the light source using the dummy pixels of the image sensor.

16. An image scanning apparatus comprising:
a charge coupled device (CCD) assembly which comprises a light source and an image sensor;
a white sheet which comprises a dummy scan portion used to calculate shading compensation factors and an initial luminance value before an image scan, and a luminance detection portion used to calculate a real-time luminance value during the image scan;
a memory which stores the shading compensation factors;
a shading compensation factor updater which updates the shading compensation factors using a luminance signal obtained by the image sensor; and
a shading compensator which performs compensation on image data obtained by the image sensor using the shading compensation factors.

17. The image scanning apparatus of claim 16, wherein:
the image sensor comprises dummy pixels corresponding to the luminance detection portion of the white sheet; and
a white level is detected using the dummy pixels in the luminance detection portion.

18. The image scanning apparatus of claim 16, wherein the light source is a cold cathode fluorescent lamp (CCFL) extending in the same direction as the image sensor.

19. The image scanning apparatus of claim 17, wherein the light source is a cold cathode fluorescent lamp (CCFL) extending in the same direction as the image sensor.

20. The image scanning apparatus of claim 18, wherein the dummy scan portion of the white sheet extends in the same direction as the CCFL, and the luminance detection portion of the white sheet extends in a moving direction of the CCD assembly.
